(19) United States
(12) Patent Application Publication
(10) Pub. No.: US 2014/0183763 A1
(43) Pub. Date: Jul. 3, 2014

(54) HUMIDIFIER FOR FUEL CELL SYSTEM

(71) Applicants: HYUNDAI MOTOR COMPANY, Seoul (KR); KIA MOTORS CORPORATION, Seoul (KR)

(72) Inventors: Jin Woo Koo, Seoul (KR); Hyun Yoo Kim, Seoul (KR); Sang Hoon Seo, Gyeonggi-do (KR); Hyuck Roul Kwon, Gyeonggi-do (KR)

(73) Assignees: KIA MOTORS CORPORATION, Seoul (KR); HYUNDAI MOTOR COMPANY, Seoul (KR)

(21) Appl. No.: 13/840,144

(22) Filed: Mar. 15, 2013

(30) Foreign Application Priority Data
Dec. 28, 2012 (KR) 10-2012-0156292

(51) Int. Cl. H01M 8/04

(52) U.S. Cl. CPC H01M 8/04126
USPC 261/112.2

(57) ABSTRACT

Disclosed is a humidifier for a fuel cell system including a separator plate which is corrugated to provide an alternating concave-convex surface, and humidifying films provided at an upper end and a lower end of the separator plate, respectively. More specifically, the separator plate and the humidifying films form a series of drift spaces in which a width of an upper end portion is different from a width of a lower end portion which is contact with the humidifying film.

### CROSS-REFERENCE

This application claims priority under 35 U.S.C. §119 to Korean Patent Application No. 10-2012-0156292 filed on, Dec. 28, 2012, the disclosure of which is hereby incorporated by reference in its entirety.

### BACKGROUND

1. Field of the Invention

The present invention relates to a humidifier for a fuel cell system which performs heat transfer and humidification effectively and efficiently.

2. Description of the Related Art

In a fuel cell system, when supplying air to an air electrode, air is typically first humidified before being supplied to the air electrode, for the purpose of improving reaction efficiency. The main issue regarding the humidifier used for this purpose is the need for an improvement in humidification efficiency.

A humidifier for reaction gas may enhance sealing capability of a humidifier 10 for reaction gas and ensure the stiffness in the stacking direction. A stack 56 of the humidifier 10 for reaction gas has a first separator 52 and a second separator 54 arranged on both sides of a water permeable membrane 50. The first separator 52 has recessed parts 74a, 74b formed in first projections 62b, 64b corresponding to connecting portions of an air supply communication aperture 58a and an air exhaust communication aperture 58b with first passage grooves 62a, 64a. Plate-like members 76a, 76b are arranged in recessed parts 74a, 74b, and the plate-like members 76a, 76b are overlapped in the stacking direction with a seal 72 of the second separator 54 on both sides of the water permeable membrane 50.

However, in the above example, humidifying performance per unit volume is lower than what is desired because the area of an effective film serving as a humidifying film is quite narrow. Additionally, the diffusion rate is also lower than what is desired because the shapes of a passage through which wet air flows and a passage through which dry air flows are not suitable for transferring moisture, impairing humidifying efficiency. Finally, in the above example, most of the heat is transferred only through the humidifying film. Thus, there is a need for a humidifier that performs more effectively and efficiently.

The foregoing is intended merely to aid in the understanding of the background of the present invention, and is not intended to mean that the present invention falls within the purview of the related art that is already known to those skilled in the art.

### SUMMARY

Accordingly, the present invention has been made keeping in mind the above problems occurring in the related art, and the present invention is intended to propose a humidifier for a fuel cell system which enables effective and efficient heat transfer and humidification.

In order to achieve the above object, according to one aspect of the present invention, there is provided a humidifier for a fuel cell system that includes a separator plate corrugated to provide an alternating concave-convex surface, and humidifying films combined with an upper end and a lower end of the separator plate. The separator plate and humidifying films form a continuous drift space and the separator plate is corrugated such that a width of an upper portion of the drift space is different from a width of a lower end portion of the drift space which is in contact with the humidifying film.

In some exemplary embodiments, the drift space may have a trapezoid shape, and/or may be a series of drift spaces, and among the series of drift spaces, a width of an upper end portion may be larger than a width of a lower end portion in a specific drift space and the width of the upper end portion may be smaller than the width of the lower end portion in the drift spaces disposed on both sides of the specific drift space.

Each of the series of drift spaces formed between the humidifying films may have a trapezoid shape and every other drift space may be reversed in shape accordingly Wet air may flow through the specific drift space, and dry air may flow through the drift spaces which are disposed on both sides of the specific drift space, and the drift spaces which are disposed on upper and lower sides of the drift space. The separator plate may also be made of a heat conductor so that heat may be transferred efficiently therethrough.

The humidifier for a fuel cell system having the structure described above separately manages moisture transfer and heat transfer and maximizes each of the functions so that an efficient humidifier can be provided. Furthermore, the area of an effective film is increased and humidification performance is improved while minimizing the support surface area. Yet further, as a wet side and a dry side are adjacent to each other with a separator plate acting as a border, heat transfer from the wet side to the dry side is improved (in fact excellent) and the humidification efficiency improves as a result.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a cross-sectional view illustrating a humidifier for a fuel cell system according to one exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinbelow, preferred embodiments of the present invention will be described in detail with reference to the accompanying drawings.

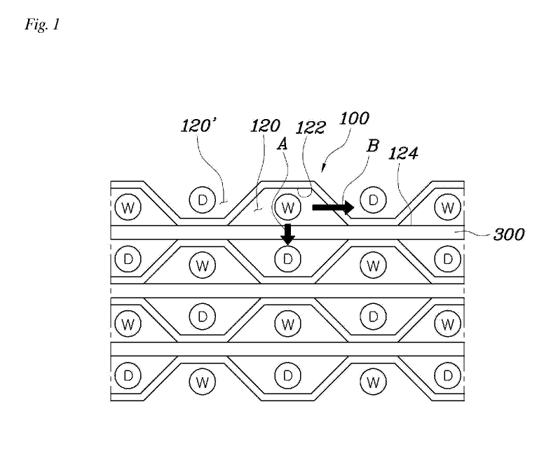

FIG. 1 is a cross-sectional view illustrating a humidifier for a fuel cell system according to one embodiment of the present invention.

The present invention relates to a humidifier for a fuel cell system which enables effective heat transfer and humidification. In order to achieve an object of the present invention, the humidifier for a fuel cell system includes a separator plate 100 which is corrugated to provide an alternating concave-convex surface, and humidifying films 300 combined with an upper end and a lower end of the separator plate 100, respectively. The humidifying films 300 combined with the separator plate 100 form a continuous drift space 120. The separator plate 100 is corrugated so that an area of an upper end portion 122 of the drift space 120 is different from an area of a lower end portion 124 of the drift space 120 which is in contact with the humidifying film 300.

According to the present invention, the corrugated separator plate 100 is interposed between two humidifying films 300 provided as upper and lower films so that the drift space is formed between the separator plate 100 and the humidifying film 300.

In the drift spaces 120, wet air W and dry air D alternately drift. Specifically, the separator plate 100 is formed to provide an alternating concave-convex surface. The separator plate 100 is corrugated such that the width of the upper end portion 122 of the drift space 120 is not the same as the width of the lower end 124 of the drift space 120. That is, the drift space 120 does not have a rectangular shape. The separator plate 100 is obliquely bent at an equal angle at every bending portion so that the width of the upper end portion 122 of the drift space 120 is different from the width of the lower end portion 124 of the drift space 120 which is in contact with the humidifying film 300.

When there is a series of drift spaces 120, the width of the upper end portion 122 of the drift space 120 is larger than the width of the lower end portion 124 of the drift space 120 in the case of a specific drift space, and the width of the upper end portion 122 of the drift space 120 is smaller than the width of the lower end portion 124 of the drift space 120 in the case of drift spaces 120 which are disposed on both sides of that specific drift space 120. The wet air may flow through that specific drift space 120 and the dry air may flow through the drift spaces 120 provided on both sides of the specific drift space 120 and on upper and lower sides of the specific drift space 120.

Preferably, the drift space may have a trapezoidal shape as illustrated in the drawing. Each of the series of drift spaces 120 formed between the humidifying films 300 may have a trapezoidal shape as well and other drift spaces may be reversed in shape. The separator plate 100 may be made of a heat conductor so that heat can be transferred from the wet air to the dry air, promoting condensation.

Specifically, according to the principle of the present invention, as the wet air W and the dry air D are alternately supplied to portions of the same separator plate 100, heat transfer through the separator plate 100 is maximized. By adopting the trapezoidal structure of a fluid passage, it is possible to guide the air to the humidifying films 300 and reduce the area of the supporting surface. That is, the structure adopted in the present invention is a plate-like passage structure which can maximize the effective area of the films In this way, the present invention adopts the structure which separately manages function and performance of water transfer through the humidifying films 300 and function and performance of heat transfer through the separator plate 100. This maximizes humidification performance

On the other hand, according to the exemplary embodiment of the present invention, as the separator plate 100 is made of metal or plastic, having heat transfer properties, the heat transfer from the wet side (e.g., hot and humid exhaust air from a stack) to the dry side (e.g., dry air) is maximized. In addition, according to the exemplary embodiment of the present invention, the humidifying films 300 function to transfer a material (water or vapor) efficiently and effectively.

The major functions of the humidifier used for a fuel cell system include transferring a material (e.g., water and/or vapor) and transferring heat to maintain the transferred material in gaseous state while the function of a general humidifier is to perform heat transfer and material transfer through only a humidifying film. In the case of general humidifying films, to improve performances of material transfer and heat transfer, transmittance of the humidifying film 300 is improved by increasing a pore size. In such a case, the heat transfer function of the humidifying film 300 is deteriorated. However, in the exemplary embodiment of the present invention, both of the functions are separately managed so that material transfer is performed through the humidifying film 300 and the heat transfer is performed through the separator plate 100 formed of a heat conductor.

In the trapezoidal passage structure illustrated in the drawing, the pressure is higher in an upper portion of the passage than in a lower portion of the passage because the area of the cross section of the upper portion is smaller than that of the lower portion. Accordingly the air which flows through the passage mainly flows in the portion having a larger cross section area. For this reason, the amount of time during which the wet air and the dry air are adjacent to each other on both sides of the humidifying film, respectively, increases. Accordingly, the diffusion rate of the wet air into the dry air increases.

In addition, when vapor in the wet air passes through the humidifying film 300 and reaches the passage of the dry air, the moisture in the wet air first condenses on a first surface of the humidifying film 300 which is in contact with the wet air, and then moves to a second surface of the humidifying film 300 which is in contact with the dry air. For this reason, it is necessary to lower the temperature so that the vapor can condense. For this purpose, the separator plate 100 having a high heat transfer performance should be used. Therefore, the wet air W and the dry air D are present on both sides of the separator plate 100, the heat of the wet air having a high temperature is transferred to the dry air having a low temperature through the separator plate 100, and the vapor is easily transferred by condensing on the surface of the film.

That is, as the wet side and the dry side are adjacent to each other and present on both sides of the separator plate 100, the heat transfer effect from the wet air to the dry air is excellent, and thus the humidification effect can be maximized. In addition, as the trapezoidal passage structure of the embodiment of the present invention increases the diffusion rate of the wet air into the dry air in comparison with the conventional art, the humidification efficiency improves.

In addition, as the exemplary embodiment of the present invention provides the structure which causes the air to collect on the surface of the humidifying film 300, the contact between the humidifying film 300 and the air is facilitated. Further, in the structure in which the wet air exhausted from a fuel cell stack is transferred to the dry air through the humidifying film 300, as the passage structure has a trapezoidal shape, the drifting air collects near the humidifying film 300. This improves the material transfer performance Further still, as the area of the supporting space is minimized and the area of the effective film increases, the humidification performance is improved as a result. Furthermore, as the heat is transferred from the wet side to the dry side through the separator plate 100 having an excellent heat transfer properties, humidification through the humidifying film 300 may be smoothly attained.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A humidifier for a fuel cell system comprising:
a separator plate corrugated to provide an alternating concave-convex surface; and
humidifying films combined with an upper end and a lower end of the separator plate, respectively,
wherein the separator plate and the humidifying films form a series of drift spaces, and the separator plate is corrugated so that a width of an upper end portion of the drift space is different from a width of a lower end portion of the drift space which in contact with an humidifying film

2. The humidifier for a fuel cell system according to claim 1,
wherein the drift space has a trapezoidal shape.

3. The humidifier for a fuel cell system according to claim 1,
wherein the width of an upper portion is larger than a width of a lower portion in a specific drift space among a first series of drift spaces, and the width of the upper portion is smaller than the width of the lower portion in drift spaces disposed on both sides of the specific drift space among a second series of drift spaces.

4. The humidifier for a fuel cell system according to claim 1,
wherein the drift spaces formed between the humidifying films have a trapezoidal shape, and every other drift space is reversed in shape.

5. The humidifier for a fuel cell system according to claim 1,
wherein wet air flows through the specific drift space and dry air flows through the drift spaces disposed on both sides of the separator plate and on upper and lower sides of the specific drift space.

6. The humidifier for a fuel cell system according to claim 1,
wherein the separator plate is made of a heat conductor.
